(19) United States
(12) Patent Application Publication
(10) Pub. No.: US 2025/0119502 A1
(43) Pub. Date: Apr. 10, 2025

(54) INFORMATION PROCESSING APPARATUS, INFORMATION PROCESSING SYSTEM, AND INFORMATION PROCESSING PROGRAM

(71) Applicant: FUJIFILM CORPORATION, Minato-ku, Tokyo (JP)

(72) Inventor: Yoshihiro SEKINE, Kanagawa (JP)

(21) Appl. No.: 18/567,359

(22) PCT Filed: Jul. 4, 2022
(86) PCT No.: PCT/JP2022/026642

§ 371 Date: Dec. 6, 2023

(30) Foreign Application Priority Data
Jul. 29, 2021 (JP) 2021-124756

(51) Int. Cl. H04N 1/00

(52) U.S. Cl. CPC H04N 1/00506; H04N 1/00411

(57) ABSTRACT

An information processing apparatus includes a processor, the processor performing a process to: display on a display unit an operational part movable along a predetermined direction when executing a function for which setting information has been preset; sequentially display the setting information on the display unit in accompaniment with the progression of a moving operation of moving the operational part; and execute the function after the end of the moving operation.

### TECHNICAL FIELD

The present disclosure relates to an information processing apparatus, an information processing system, and an information processing program.

### BACKGROUND ART

JP-A No. 2000-194482 proposes an operation program registration system where, by pressing an unregistered one-touch key instead of a start key, setting parameters necessary for operating a facsimile machine or the like and instructed by a series of operations from an operation display unit are registered as a program in the same format as a normal operation job file in correspondence to the one-touch key, whereby the user can, by pressing the one-touch key, repeatedly execute the registered program.

JP-A No. 2013-164677 proposes an image processing apparatus, and a method of controlling the same, that slidingly displays items being displayed in a list in response to an instruction operation from a user and, when it determines there is change in an item that should be displayed in the list, for example stops the sliding display or notifies the user that there is change in the items being displayed in the list by highlighting the item.

JP-A No. 2005-31500 proposes an image forming apparatus including: a display unit for switching between and displaying plural types of setting confirmation screens relating to image formation; a selection unit for selecting various types of operating modes; and a display control unit which, when a switch operation to switch to the setting confirmation screens has occurred in the operating mode that has been selected by the selection unit, performs control to select and display on the display unit one of the plural types of setting confirmation screens in accordance with the selected operating mode.

JP-A No. 2013-235006 proposes a waveform observation apparatus in which is executed a process to scroll a waveform chart by causing it to track the movement of a fingertip moving on a monitor, so that on the monitor, the waveform chart tracks and scrolls in the direction in which the fingertip moves and at substantially the same speed as the speed at which the fingertip moves. In this waveform observation apparatus, immediately after the operator removes his/her fingertip from the monitor, the moving speed of the fingertip is calculated by the moving distance and time from the point in time when the operator touched the monitor before and started moving his/her fingertip to the point in time when the operator removed his/her fingertip from the monitor, and if the moving speed is higher than a threshold, scrolling is executed by fast-forwarding at a speed corresponding to the moving speed from the initial touch until command means such as the fingertip moves away from the monitor.

### SUMMARY OF INVENTION

### Technical Problem

When a user checks setting information associated with functions to be executed when executing functions such as copying, image reading, and transmitting, the user can check the setting information by transitioning the screen to a setting screen that displays the setting information. However, because the user needs to transition to the setting screen to check the setting information, operation steps have been burdensome.

Thus, it is an object of the present disclosure to provide an information processing apparatus, an information processing system, and an information processing program with which it is easy to check setting information associated with a function to be executed compared with transitioning to a setting screen to check the setting information.

### Solution to Problem

In order to achieve the above object, an information processing apparatus pertaining to a first aspect includes a processor, the processor performing a process to: display on a display unit an operational part movable along a predetermined direction when executing a function for which setting information has been preset; sequentially display the setting information on the display unit in accompaniment with the progression of a moving operation of moving the operational part; and execute the function after the end of the moving operation.

Furthermore, an information processing apparatus pertaining to a second aspect is the information processing apparatus pertaining to the first aspect, wherein the processor displays the setting information that is displayable when a touch on the operational part has been detected and sequentially displays the setting information that is not being displayed when the moving operation has been detected.

Furthermore, an information processing apparatus pertaining to a third aspect is the information processing apparatus pertaining to the first aspect or the second aspect, wherein the processor sequentially displays the setting information by scrolling and displaying the setting information or sequentially switching to and displaying screens in which the area where the setting information is displayed is changed.

Furthermore, an information processing apparatus pertaining to a fourth aspect is the information processing apparatus pertaining to the third aspect, wherein the processor scrolls the setting information at a predetermined speed in accordance with the speed of the moving operation of the operational part or switches to screens in which the area where the setting information is displayed is changed at the predetermined speed.

Furthermore, an information processing apparatus pertaining to a fifth aspect is the information processing apparatus pertaining to the third aspect, wherein the processor scrolls the setting information, or switches to screens in which the area where the setting information is displayed is changed, at a speed slower than the speed of the moving operation of the operational part.

Furthermore, an information processing apparatus pertaining to a sixth aspect is the information processing apparatus pertaining to any one of the first aspect to the fifth aspect, wherein the processor executes the function after the elapse of a predetermined amount of time after the moving operation of the operational part is completed.

Furthermore, an information processing apparatus pertaining to a seventh aspect is the information processing apparatus pertaining to any one of the first aspect to the sixth aspect, wherein the processor displays the setting information in a position in which it will not obstruct the moving operation of the operational part.

Furthermore, an information processing apparatus pertaining to an eighth aspect is the information processing apparatus pertaining to any one of the first aspect to the seventh aspect, wherein when displaying the setting information, the processor further displays an image representing a document that is an execution target.

Furthermore, an information processing apparatus pertaining to a ninth aspect is the information processing apparatus pertaining to the eighth aspect, wherein the processor sequentially displays the setting information while keeping the image fixed.

Furthermore, an information processing apparatus pertaining to a tenth aspect is the information processing apparatus pertaining to any one of the first aspect to the ninth aspect, wherein a display order of the setting information is an order that prioritizes the setting information that has been changed from predetermined initial settings.

Furthermore, an information processing system pertaining to an eleventh aspect includes: the information processing apparatus; and an image forming apparatus that sends the setting information to the information processing apparatus and receives execution of the function from the information processing apparatus.

Furthermore, an information processing program pertaining to a twelfth aspect causes a computer to execute a process to: display on a display unit an operational part movable along a predetermined direction when executing a function for which setting information has been preset; sequentially display the setting information on the display unit in accompaniment with the progression of a moving operation of moving the operational part; and execute the function after the end of the moving operation.

### Advantageous Effects of Invention

According to the first aspect, there can be provided an information processing apparatus with which it is easy to check setting information associated with a function to be executed compared with transitioning to a setting screen to check the setting information.

According to the second aspect, some of the setting information can be checked together with starting the operation of executing the function.

According to the third aspect, the setting information can be sequentially displayed by the moving operation of the operational part and checked.

According to the fourth aspect, it becomes possible to adjust the display speed of the setting information by adjusting the moving speed of the operational part.

According to the fifth aspect, the setting information can be inhibited from becoming unreadable.

According to the sixth aspect, it becomes possible to check for operational errors and cancel the execution of the function within the predetermined amount of time.

According to the seventh aspect, the moving operation of the operational part can be prevented from being obstructed as a result of the setting information being displayed.

According to the eighth aspect, a document that is an execution target can be checked together with the setting information.

According to the ninth aspect, the setting information can be checked while constantly checking the image of the execution target.

According to the tenth aspect, the setting information that has been changed from the initial settings can be prioritized and checked.

According to the eleventh aspect, there can be provided an information processing system with which it is easy to check setting information associated with a function to be executed compared with transitioning to a setting screen to check the setting information.

According to the twelfth aspect, there can be provided an information processing program with which it is easy to check setting information associated with a function to be executed compared with transitioning to a setting screen to check the setting information.

### BRIEF DESCRIPTION OF DRAWINGS

FIG. 1 is a block diagram showing main configurations of an image forming apparatus pertaining to an embodiment.

FIG. 2 is a block diagram showing an example of functional configurations of the image forming apparatus pertaining to the embodiment.

FIG. 3 is a diagram showing how, when a user selects a pinned copy process, conventional image forming apparatus display a screen that displays setting information and a preview image when executing the copy process.

FIG. 4 is a diagram showing an example where, when the user selects a pinned copy process, the image forming apparatus pertaining to the embodiment displays a slide-to-start field in a position on a list where the selected copy process was displayed.

FIG. 5 is a diagram showing an example where the image forming apparatus pertaining to the embodiment sequentially displays, by scrolling, setting information associated with the copy process in accompaniment with the progression of a moving operation of a slide button in the slide-to-start field.

FIG. 6 is a diagram showing an example where, when the user selects a pinned fax process, the image forming apparatus pertaining to the embodiment displays the slide-to-start field in a position on a list where the selected fax process was displayed.

FIG. 7 is a diagram showing an example where the image forming apparatus pertaining to the embodiment sequentially displays, by scrolling, setting information associated with the fax process in accompaniment with the progression of the moving operation of the slide button in the slide-to-start field.

FIG. 8 is a flowchart showing an example of a flow of processes performed by the image forming apparatus pertaining to the embodiment.

FIG. 9 is a diagram showing an example of an information processing system including the image forming apparatus and a mobile terminal device.

FIG. 10 is a diagram showing an example of an example modification of the display position of the slide-to-start field.

### DESCRIPTION OF EMBODIMENT

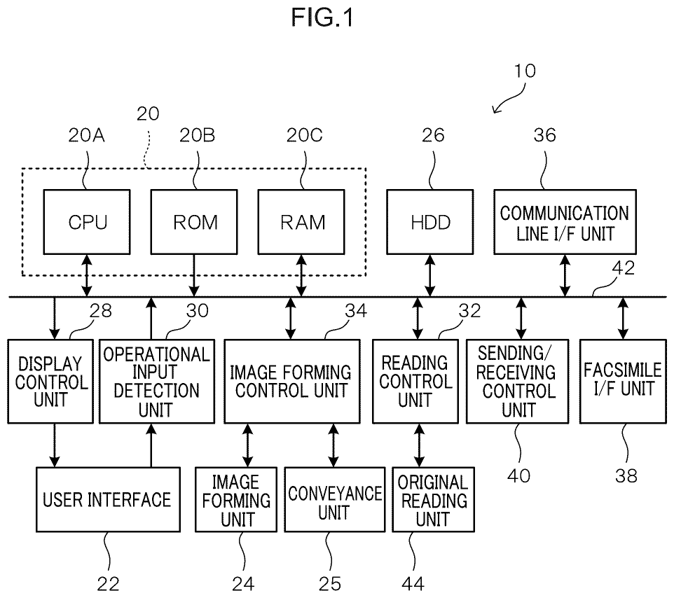

An example of an embodiment of the present disclosure will be described in detail below with reference to the drawings. In the present embodiment, an image forming apparatus will be described as an example of the information processing apparatus. FIG. 1 is a block diagram showing main configurations of the image forming apparatus pertaining to the present embodiment.

As an image forming apparatus 10 pertaining to the present embodiment, an image forming apparatus having multiple functions, such as a facsimile function, an image reading function, an image forming function, a copy function, a storage function for storing image information and the like, and a send function for sending image information and the like, may be applied as an example. It will be noted that, below, sometimes the facsimile function is called faxing, the image reading function is called scanning, and the copy function is called copying.

As shown in FIG. 1, the image forming apparatus 10 pertaining to the present embodiment includes a control unit 20 including a central processing unit (CPU) 20A serving as an example of a processor, a read-only memory (ROM) 20B, and a random-access memory (RAM) 20C. The CPU 20A controls the operations of the entire image forming apparatus 10. The RAM 20C is used as a workspace or the like when the CPU 20A executes various types of programs. In the ROM 20B, various types of control programs and various types of parameters are prestored. Additionally, in the image forming apparatus 10, the parts of the control unit 20 are electrically interconnected by a system bus 42.

Furthermore, the image forming apparatus 10 pertaining to the present embodiment includes a hard disk drive (HDD) 26 that stores various types of data and application programs. Furthermore, the image forming apparatus 10 includes a display control unit 28 that is connected to a user interface 22 and controls the display of various types of operation screens and the like on a display of the user interface 22. Furthermore, the image forming apparatus 10 includes an operational input detection unit 30 that is connected to the user interface 22 and detects operational instructions input via the user interface 22. Additionally, in the image forming apparatus 10, the HDD 26, the display control unit 28, and the operational input detection unit 30 are electrically connected to the system bus 42. It will be noted that although the HDD 26 is applied as a storage unit in the image forming apparatus 10 pertaining to the present embodiment, the storage unit is not limited thereto, and a nonvolatile storage unit such as flash memory may also be applied.

Furthermore, the image forming apparatus 10 pertaining to the present embodiment includes a reading control unit 32, which controls optical image reading operations by an original reading unit 44 and original feeding operations by an original conveyance unit, and an image forming control unit 34, which controls image forming processes by an image forming unit 24 and paper sheet conveyance to the image forming unit 24 by a conveyance unit 25. Furthermore, the image forming apparatus 10 includes a communication line interface (I/F) unit 36 for sending communication data to and receiving communication data from other external devices connected to a communication line 16 of various types of networks and sending and receiving communication data by short-range wireless communication with devices as mobile terminal devices. Furthermore, the image forming apparatus 10 includes a facsimile interface (I/F) unit 38 that is connected to a telephone line (not shown in the drawings) and is for sending facsimile data to and receiving facsimile data from facsimile machines connected to the telephone line. Furthermore, the image forming apparatus 10 includes a sending/receiving control unit 40 that controls the sending and receiving of facsimile data via the facsimile I/F unit 38. Additionally, in the image forming apparatus 10, the sending/receiving control unit 40, the reading control unit 32, the image forming control unit 34, the communication line I/F unit 36, and the facsimile I/F unit 38 are electrically connected to the system bus 42.

Because of the above configurations, the image forming apparatus 10 pertaining to the present embodiment uses the CPU 20A to execute access to each of the RAM 20C, the ROM 20B, and the HDD 26. Furthermore, the image forming apparatus 10 uses the CPU 20A to execute control of the display of operation screens and information such as various types of messages on the display of the user interface 22 via the display control unit 28. Furthermore, the image forming apparatus 10 uses the CPU 20A to execute control of the actuation of the original reading unit 44 and the original conveyance unit via the reading control unit 32. Furthermore, the image forming apparatus 10 uses the CPU 20A to execute control of the actuation of the image forming unit 24 and the conveyance unit 25 via the image forming control unit 34 and control of the sending and receiving of communication data via the communication line I/F unit 36. Furthermore, the image forming apparatus 10 uses the CPU 20A to execute control of the sending and receiving of facsimile data via the facsimile I/F unit 38 by the sending/receiving control unit 40. Moreover, the image forming apparatus 10 uses the CPU 20A to grasp operational content in the user interface 22 based on operational information detected by the operational input detection unit 30 and execute various types of control based on the operational content.

Furthermore, the image forming apparatus 10 pertaining to the present embodiment has the function of performing what is called pinning and re-executing a function by applying an operator in a case where, when executing a function such as copying, faxing, emailing, or scanning or when executing a combination of these functions, the function is executed after its setting information has been changed from setting defaults. It will be noted that the operator corresponds to a pin for pinning and is associated with the setting information.

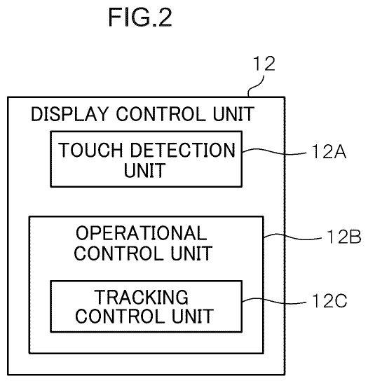

FIG. 2 is a block diagram showing an example of functional configurations of the image forming apparatus 10 pertaining to the present embodiment.

As shown in FIG. 2, in the image forming apparatus 10 pertaining to the present embodiment, the CPU 20A functions as a display control unit 12 by executing a program stored in the ROM 20B. The display control unit 12 includes the functions of a touch detection unit 12A and an operational control unit 12B.

The touch detection unit 12A detects the touch and touch position of a user's finger on the display of the user interface 22. Additionally, the operational control unit 12B has a control function for controlling the display of images on the display of the user interface 22 and a control function for controlling the execution of functions and the cancellation of the execution of functions corresponding to operational buttons displayed as images on the display based on the detection results of the touch detection unit 12A.

The operational control unit 12B includes a tracking control unit 12C, and the tracking control unit 12C performs control to display images on the display of the user interface 22 and control to display, so as to track a moving operation by the user, a slide button in a slide-to-start field serving as an example of an operational button displayed as an image. That is, the tracking control unit 12C displays an operational button such as a slide-to-start field on the display, and when a moving operation with respect to the slide button in the slide-to-start field is performed by the user, the tracking control unit 12C displays the slide button in the slide-to-start field in positions on the display that track the moving operation.

Furthermore, the operational control unit 12B controls the non-execution of functions or the execution of functions in correspondence to the position of the slide button when the moving operation is completed in regard to the slide button displayed so as to track the moving operation by the user. “Non-execution of functions” is control that maintains a state in which execution of a function is not started (e.g., an initial state) due to the moving operation not going as far as instructing execution of the function. Furthermore, control of the execution of functions includes control to execute predetermined functions or control to cancel the execution of predetermined functions.

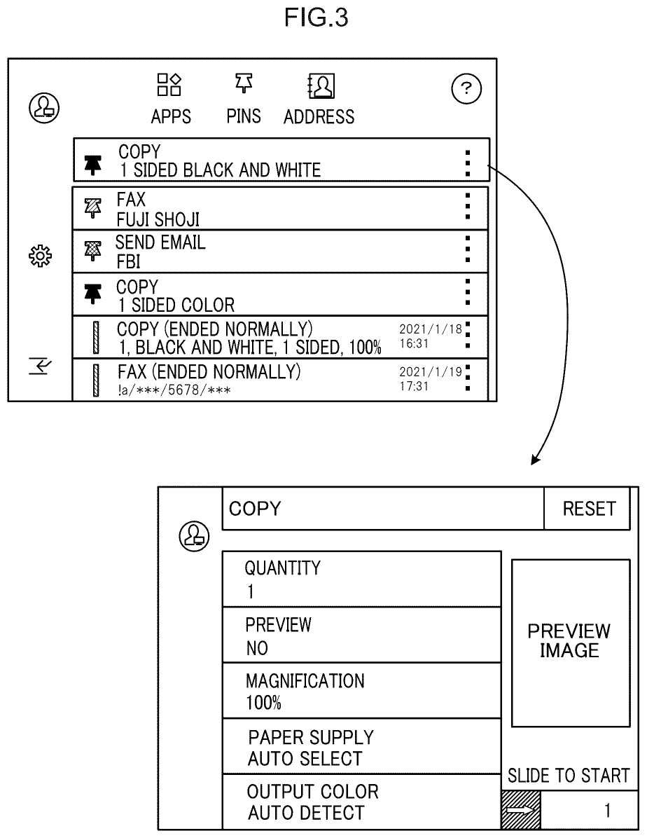

In this connection, conventional image forming apparatus display a list of pinned processes and processes executed in the past and, in order to allow the user to check setting information in the case of re-executing a process, switch to a screen that displays the setting information when the user selects the desired process as shown in FIG. 3. This allows the user to check the setting information when the selected process was executed in the past. For example, in the example of FIG. 3, when the user selects a pinned copy process, conventional image forming apparatus display a screen that displays setting information and a preview image when executing the copy process. Here, to execute the selected copy process, the user movingly operates a slide button in the arrowed portion of a slide-to-start field provided on the screen that displays the setting information and the preview image, whereby the copy process is executed. However, in the case of checking setting information associated with another pin, unless the user performs a return operation, the user is unable to consecutively check the next pin, resulting in many burdensome operation steps. The screen installed as the display of the user interface 22 is usually small, and it is difficult for the screen to display a lot of setting information, so conventional image forming apparatus switch screens to display the setting information.

Therefore, the image forming apparatus 10 pertaining to the present embodiment displays a list of pinned processes and processes executed in the past. Then, when a target process is selected, the image forming apparatus 10 displays, without switching to a screen for checking the setting information, a slide-to-start field including a slide button serving as an operational part movable along a predetermined direction on the screen in which the list is displayed. Furthermore, the image forming apparatus 10 sequentially displays the setting information in accompaniment with the progression of the moving operation of the slide button in the slide-to-start field. When displaying the setting information, the image forming apparatus 10 provides a display area in a position in which the setting information will not obstruct the moving operation of the slide button and sequentially displays the setting information. Because of this, in the case of consecutively checking setting information associated with other processes, when the selects the other processes, the setting information is displayed. Below, as an example of sequentially displaying the setting information, an example where the image forming apparatus 10 scrolls and displays the setting information will be described as an example, but the image forming apparatus 10 may also sequentially switch to and display screens in which the area where the setting information is displayed is changed in the same way as a scroll display. For example, the image forming apparatus 10 may display the setting information that is displayable and sequentially switch to and display screens in which the setting information is changed to the setting information that is not being displayed, or screens in which the setting information is changed to partially redundant setting information and the setting information that is not being displayed, in accompaniment with the progression of the moving operation of the slide button in the slide-to-start field

Furthermore, the image forming apparatus 10 executes the process after the slide button in the slide-to-start has been moved to the end of a predetermined moving range. However, when the user removes his/her finger without moving it to the end, or when the user removes his/her finger after moving it back in the original direction from the end, the process is not executed.

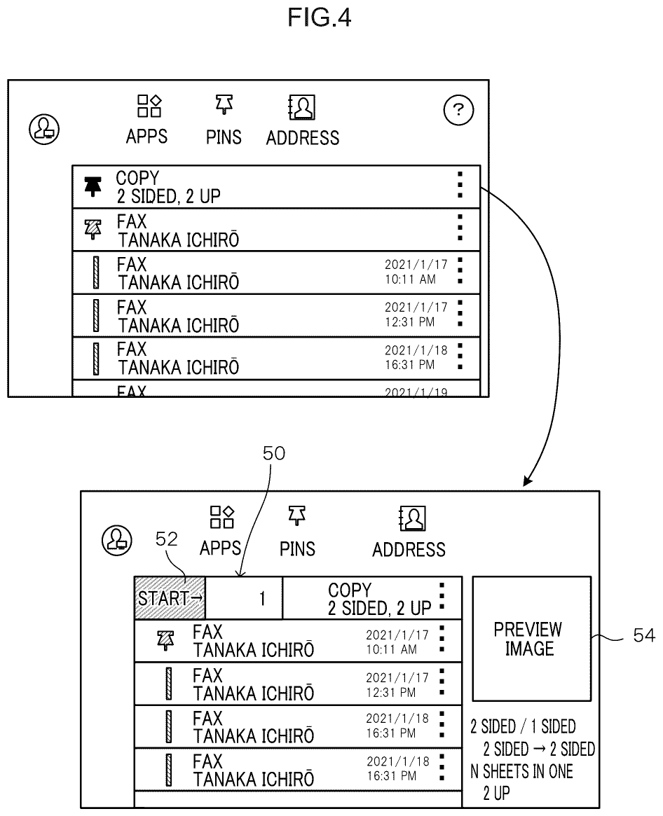

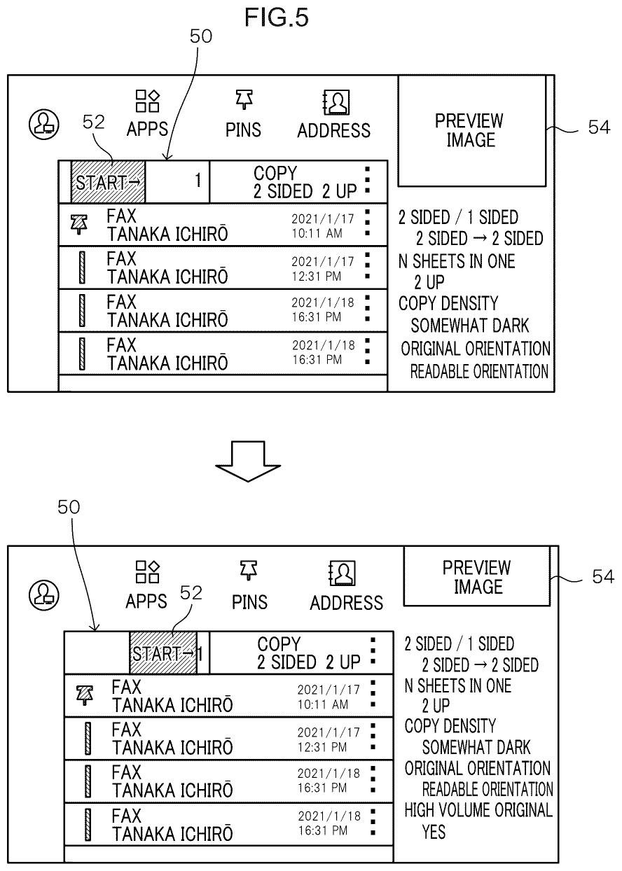

Specifically, as shown in FIG. 4, when a copy process to which an operator has been assigned and which has been pinned is selected, a slide-to-start field 50 is displayed in the position on the list where the selected copy process was displayed. Furthermore, a preview image 54 serving as an image representing a target document is displayed on the right side of the screen and a displayable number of sets of the setting information are displayed. As the preview image 54, for example, a thumbnail image of the first page or an image of the first row of characters may be displayed. Additionally, as shown in FIG. 5, the setting information associated with the copy process is sequentially displayed by scrolling in accompaniment with the progression of the moving operation of a slide button 52 in the slide-to-start field 50. FIG. 5 shows an example where, in the upper part of FIG. 5, setting information where the “2 Sided/1 Sided” setting is “2 Sided->2 Sided”, the “N Sheets in One” setting is “2 Up”, the “Copy Density” setting is “Somewhat Dark”, and the “Original Orientation” setting is “Readable Orientation” is displayed and, in the lower part of FIG. 5, the setting information is scrolled by the progression of the moving operation of the slide button 52 so that the setting information displayed in the upper part of FIG. 5 is scrolled and setting information where the “High Volume Original” setting is “Yes” is further displayed.

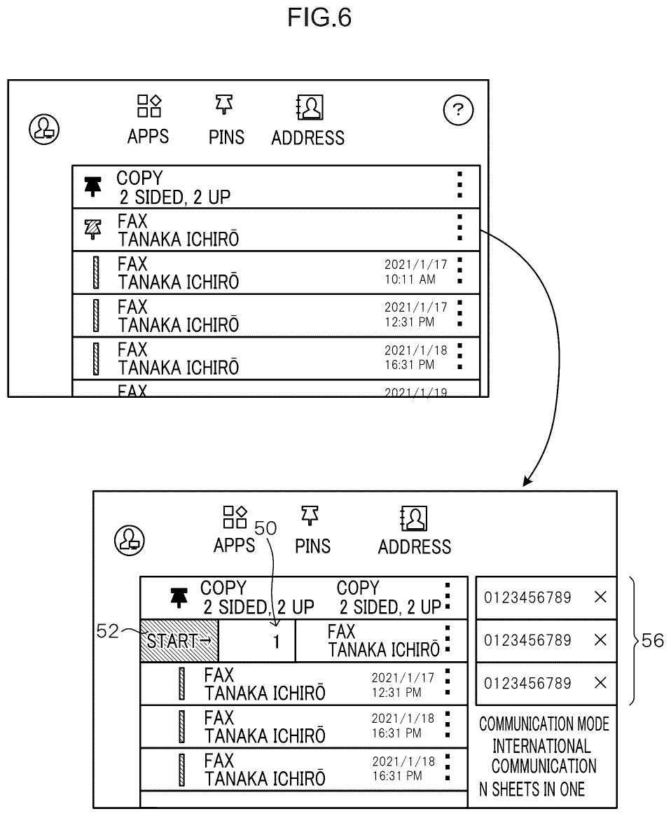

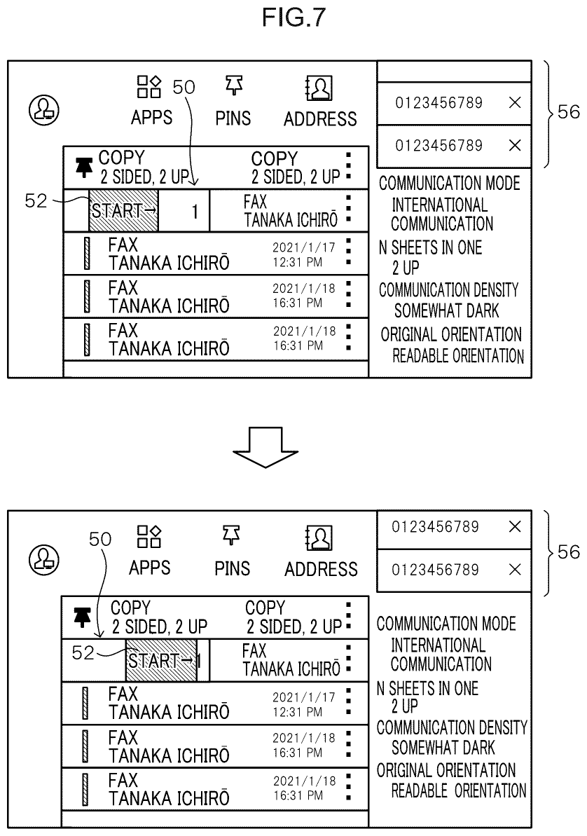

Furthermore, as shown in FIG. 6, when a fax process to which an operator has been assigned and which has been pinned is selected, the slide-to-start field 50 is displayed in the position on the list where the selected fax process was displayed. Furthermore, a destination list 56 is displayed on the right side of the screen and a displayable number of sets of the setting information are displayed. Additionally, as shown in FIG. 7, the setting information is sequentially displayed by scrolling in accompaniment with the progression of the moving operation of the slide button 52 in the slide-to-start field 50. In the upper part of FIG. 7, setting information where the “Communication Mode” setting is “International Communication”, the “N Sheets in One” setting is “2 Up”, the “Communication Density” setting is “Somewhat Dark”, and the “Original Orientation” is “Readable Orientation” is displayed. Furthermore, in the lower part of FIG. 7, an example is shown where the setting information is scrolled by the progression of the moving operation of the slide button 52 so that the setting information displayed in the upper part of FIG. 7 is scrolled and displayed.

It will be noted that although in the above description the CPU 20A is configured to scroll the preview image 54 and the destination list 56 together with the setting information, it is not limited to this. For example, the scrolling of the preview image 54 and/or the destination list 56 may be optional, and the CPU 20A may scroll and display just the setting information that is not being displayed while keeping the display of the preview image 54 fixed. Furthermore, the CPU 20A may scroll and display the setting information at a predetermined speed at which the setting information can be read. Furthermore, the CPU 20A may scroll the setting information at a speed slower than the moving speed of the slide button 52. Furthermore, the CPU 20A may scroll the setting information at a predetermined speed in accordance with the moving speed of the slide button 52. For example, the CPU 20A may accelerate or decelerate the scrolling speed to track the moving speed of the slide button 52.

Furthermore, the setting information may be displayed in an order beginning with the top of a predetermined default setting list or may be displayed in an order that prioritizes the setting information that has been changed from its initial settings.

It will be noted that when displaying the slide-to-start field 50, the CPU 20A may be configured to display just the preview image 54 or the destination list 56 and sequentially display the setting information when the slide button 52 is movingly operated.

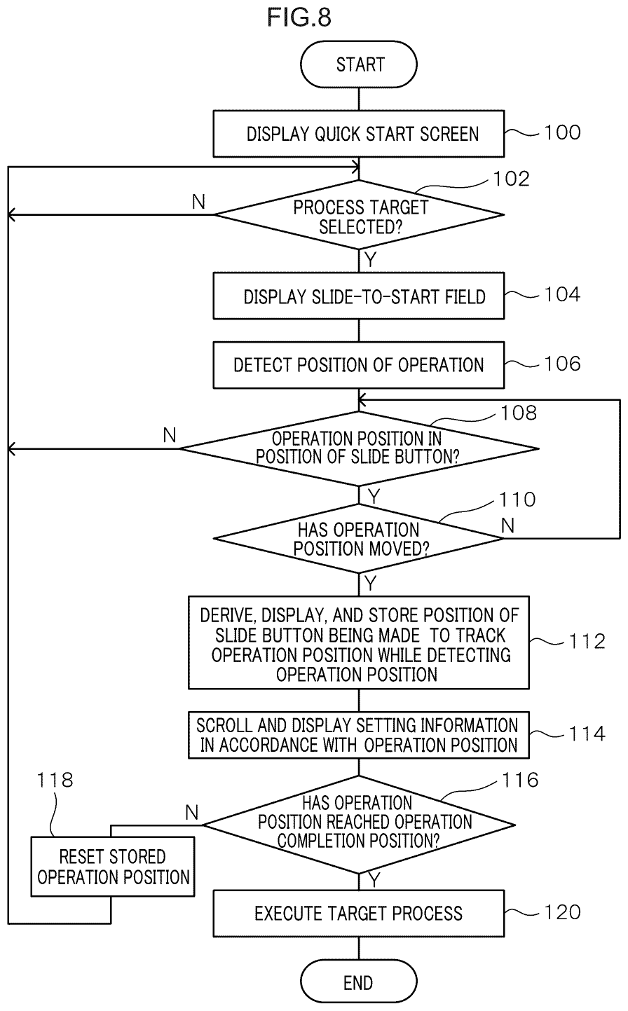

Next, specific processes performed by the image forming apparatus 10 pertaining to the present embodiment configured as described above will be described. FIG. 8 is a flowchart showing an example of a flow of processes performed by the image forming apparatus 10 pertaining to the present embodiment. The processes in FIG. 8 are started when, for example, a predetermined quick start is instructed. It will be noted that the quick start instructs the execution of a process from a list of pins including a list of past processes as shown in FIGS. 4 and 6 for example.

In step 100 the CPU 20A displays a predetermined quick start screen on the display of the user interface 22, then moves to step 102. For example, the CPU 20A displays the list shown in the upper parts of FIGS. 4 and 6.

In step 102, the CPU 20A determines whether or not a process target has been selected. The CPU 20A makes this determination by, for example, determining whether or not a process target such as the selection of the copy process in FIG. 4 or the selection of the fax process in FIG. 6 has been selected. The CPU 20A stands by until the determination becomes YES, then moves to step 104.

In step 104 the CPU 20A displays the slide-to-start field 50, then moves to step 106. That is, as shown in FIGS. 4 and 6, the CPU 20A displays the slide-to-start field 50 in the position of the selected process target (the position of the copy process in the example of FIG. 4, and the position of the fax process in the example of FIG. 6).

In step 106 the CPU 20A detects the operation position where the user's finger has touched the quick start screen, then moves to step 108. That is, the touch detection unit 12A detects the touch and the touch position of the user's finger on the display of the user interface 22.

In step 108 the CPU 20A determines whether or not the operation position detected in step 106 is the position of the slide button 52 in the slide-to-start field 50. When the determination is YES, the CPU 20A moves to step 110, and when the determination is NO, the CPU 20A returns to step 102 and the above processes are repeated. It will be noted that when the touch of the finger on the slide button 52 is detected, the CPU 20A may change the display mode of the slide-to-start field 50 or the slide button 52, by changing its color for example, to a display mode indicating a reservation to execute the function.

In step 110 the CPU 20A determines whether or not the operation position has moved. The CPU 20A makes this determination by determining whether or not a moving operation such as dragging or sliding has been performed. When the determination is YES, the CPU 20A moves to step 112, and when the determination is NO, the CPU 20A returns to step 108 and the above processes are repeated.

In step 112 the CPU 20A derives the position of the slide button 52 made to track the operation position while detecting the operation position resulting from the user's finger and displays and stores the derivation result, then moves to step 114. That is, when a moving operation with respect to the slide button 52 in the slide-to-start field 50 is performed by the user while the tracking control unit 12C is causing the slide-to-start field 50 to be displayed on the display, the tracking control unit 12C displays the slide button 52 in positions tracking the moving operation.

In step 114 the CPU 20A scrolls and displays the setting information in accordance with the operation position, then moves to step 116. For example, as shown in FIG. 4, when the copy process is selected, the CPU 20A displays the slide-to-start field 50 in the position on the list where the selected copy process was displayed. Furthermore, the CPU 20A displays the preview image 54 on the right side of the screen. Then, as shown in FIG. 5, the CPU 20A sequentially displays, by scrolling, the setting information in accompaniment with the progression of the moving operation of the slide button 52 in the slide-to-start field 50.

In step 116 the CPU 20A determines whether or not the operation position has reached an operation completion position. The CPU 20A makes this determination by determining whether or not the slide button 52 has been moved to the end of the operational area. When the operation position has not reached the operation completion position, the determination is NO and the CPU 20A moves to step 118, and when the determination is YES, the CPU 20A moves to step 120. It will be noted that the CPU 20A determines that the moving operation is completed when the user's finger is removed from the slide button 52 (which includes the tracking relationship between the user's finger and the slide button 52 being canceled).

In step 118 the CPU 20A resets the stored operation position, then returns to step 102 and repeats the above processes. That is, the operational control unit 12B controls the non-execution of the function when the moving operation is completed but did not reach the operation completion position in regard to the slide button 52 displayed so as to track the moving operation by the user.

In step 120 the CPU 20A executes the target process and ends the series of processes. That is, the operational control unit 12B controls the execution of the function when the moving operation is completed in regard to the slide button 52 displayed so as to track the moving operation by the user. For example, when the copy process is selected as shown in FIGS. 4 and 5, the copy process is executed in accordance with the setting information that has been checking by scrolling. The operational control unit 12B may execute the function immediately after the slide operation is completed, but it may also be configured to execute the function after the elapse of a predetermined amount of time after the completion of the slide operation, thereby providing a predetermined amount of time in which the user can check and cancel the process.

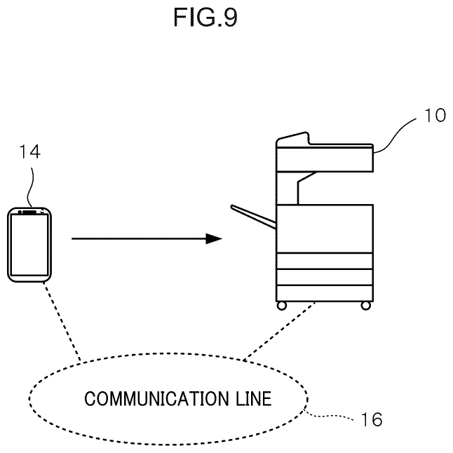

It will be noted that although in the above embodiment the image forming apparatus 10 was described as an example, the disclosure is not limited to this and may also be applied to mobile terminal devices such as smartphones as well as other devices. For example, as shown in FIG. 9, the disclosure may be applied to a case where, in an information processing system including the image forming apparatus 10 and a mobile terminal device 14, the user operates the image forming apparatus 10 from the mobile terminal device 14. In this case, the mobile terminal device 14 is communicable with the image forming apparatus 10 by short-range wireless communication, and the image forming apparatus 10 is operable from the mobile terminal device 14. For example, as the mobile terminal device 14, a tablet terminal or a smartphone may be applied as an example. Furthermore, as the short-range wireless communication, Wi-Fi (registered trademark) or Bluetooth (registered trademark) may be applied as an example. Additionally, when the setting information is sent from the image forming apparatus 10 to the mobile terminal device 14 as a result of the mobile terminal device 14 and the image forming apparatus 10 communicating with each other, execution of the functions of the image forming apparatus 10 is performed in the same way as in the above embodiment while the user checks the setting information using the mobile terminal device 14. Furthermore, in this case, the mobile terminal device 14 and the image forming apparatus 10 may also communicate with each other via a communication line 16 of a wireless base station of a mobile telephone network or the like or various types of networks (e.g., LAN, WAN, Ethernet (registered trademark)) as indicated by the dashed lines in FIG. 9 rather than by short-range wireless communication.

Furthermore, in the above embodiment, an example where, preview image 54 and the destination list 56 is displayed in an area on the right side of the screen was described as an example, but the position in which they are displayed is not limited to this, and they may be displayed in a position in which they do not get in the way of the moving operation of the slide button 52. For example, the preview image 54 and the destination list 56 may be superimposed and displayed in a position on the list other than the position of the selected target. Furthermore, when the preview image 54 and the destination list 56 are displayed, they may be displayed as an animation so that they appear to slide in.

Furthermore, in the above embodiment, an example was described where the setting information is also displayed on the right side of the screen, but the position in which the setting information is displayed is not limited to this. For example, the setting information may also be displayed in an area such as the left side, the upper side, or the lower side of the screen.

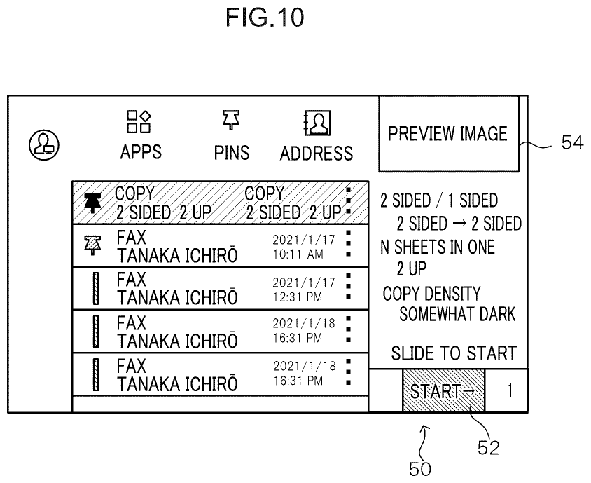

Furthermore, in the above embodiment, an example was described where the slide-to-start field 50 is displayed in the position on the list where the selected copy process or the like was displayed, but the display position of the slide-to-start field 50 is not limited to this. For example, as shown in FIG. 10, the slide-to-start field 50 may also be displayed in a position in the lower right of the screen. Alternatively, the slide-to-start field 50 may be displayed in another position such as the upper right of the screen.

Furthermore, in the above embodiment, the CPU 20A is configured to return to the selection of the process target when the user removes his/her finger without moving the slide button 52 to the end, but the CPU 20A is not limited to this. For example, the CPU 20A may also be configured to transition to a setting screen for the function being displayed, or cancel the slide-to-start field 50, or enable the selection of these.

Furthermore, in the above embodiment, a case using the quick start was described as an example, but the image forming apparatus 10 is not limited to this. For example, even with normal copy, scan, fax, and other functions, the image forming apparatus 10 may be configured to display the slide-to-start field 50, scroll and display the setting information in accompaniment with the progression of the moving operation of the slide button 52, and start executing the function while the user checks the setting information in the same way as in the above embodiment.

Furthermore, in the above embodiment, the CPU was described as an example of the processor, but “processor” refers to processors in a broad sense and includes general-purpose processors (e.g., CPUs) and dedicated processors (e.g., graphics processing units (GPUs), application-specific integrated circuits (ASICs), field-programmable gate arrays (FPGAs), and programmable logic devices).

Furthermore, the operations of the processor in the above embodiment may be performed by multiple processors in physically separate positions working together rather than being performed by only one processor. Furthermore, the order of the operations performed by the processor is not limited to the order described in each of the above embodiments and may be changed as appropriate.

Furthermore, the processes performed by the image forming apparatus 10 pertaining to the above embodiment may be processes performed by software, or processes performed by hardware, or processes combining both software and hardware. Furthermore, the processes performed by the image forming apparatus 10 may be stored as a program in storage media and circulated.

Furthermore, the present disclosure is not limited to the above and can of course be modified in various ways and implemented, in addition to what is described above, without departing from the spirit thereof.

The disclosure of Japanese Patent Application No. 2021-124756 is incorporated in its entirety herein by reference. Furthermore, all documents, patent applications, and technical standards mentioned in this specification are incorporated herein by reference to the same extent as if each individual document, patent application, or technical standard were specifically and individually indicated to be incorporated by reference.

1. An information processing apparatus including a processor, the processor performing a process to:
display, on a display unit, an operational part movable along a predetermined direction at a time of executing a function for which setting information has been preset;
sequentially display the setting information on the display unit in accompaniment with progression of a moving operation of moving the operational part; and
execute the function after the end of the moving operation.

2. The information processing apparatus of claim 1, wherein the processor displays the setting information that is displayable in a case in which a touch on the operational part has been detected and sequentially displays the setting information that is not being displayed in a case in which the moving operation has started.

3. The information processing apparatus of claim 1, wherein the processor sequentially displays the setting information by scrolling and displaying the setting information or sequentially switching to and displaying screens in which an area where the setting information is displayed is changed.

4. The information processing apparatus of claim 3, wherein the processor scrolls the setting information at a predetermined speed in accordance with a speed of the moving operation of the operational part or switches to screens in which the area where the setting information is displayed is changed at the predetermined speed.

5. The information processing apparatus of claim 3, wherein the processor scrolls the setting information, or switches to screens in which the area where the setting information is displayed is changed, at a speed slower than a speed of the moving operation of the operational part.

6. The information processing apparatus of claim 1, wherein the processor executes the function after elapse of a predetermined amount of time after the moving operation of the operational part is completed.

7. The information processing apparatus of claim 1, wherein the processor displays the setting information at a position at which it will not obstruct the moving operation of the operational part.

8. The information processing apparatus of claim 1, wherein at a time of displaying the setting information, the processor further displays an image representing a document that is an execution target.

9. The information processing apparatus of claim 8, wherein the processor sequentially displays the setting information while keeping the image fixed.

10. The information processing apparatus of claim 1, wherein a display order of the setting information is an order that prioritizes the setting information that has been changed from predetermined initial settings.

11. An information processing system comprising:
the information processing apparatus of claim 1; and
an image forming apparatus that sends the setting information to the information processing apparatus and receives execution of the function from the information processing apparatus.

12. A non-transitory computer-readable storage medium storing an information processing program executable by a computer to perform processing, the processing comprising:
display, on a display unit, an operational part movable along a predetermined direction at a time of executing a function for which setting information has been preset;
sequentially display the setting information on the display unit in accompaniment with progression of a moving operation of moving the operational part; and
execute the function after the end of the moving operation.
